(19) United States
(12) Patent Application Publication
(10) Pub. No.: US 2002/0078106 A1
(43) Pub. Date: Jun. 20, 2002

(54) Method and apparatus to spell check displayable text in computer source code

(76) Inventors: David John Carew, Austin, TX (US); Hung Dinh, Round Rock, TX (US); Teng Hu, Austin, TX (US); Mansoor Lakhdhir, Austin, TX (US)

Correspondence Address: Duke W. Yee, Carstens, Yee & Cahoon, LLP, P. O. Box 802334, Dallas, TX, 75380, US

(21) Appl. No.: 09/740,401

(22) Filed: Dec. 18, 2000

(51) Int. Cl. G06F 17/24

(52) U.S. Cl. 707/533

(57) ABSTRACT

A method, apparatus, and computer implemented instructions for spell checking text. Computer source code and external resource files are received for processing. Displayable text is identified within the computer source code. The displayable text is checked for errors.

### BACKGROUND OF THE INVENTION

1. Technical Field

The present invention relates generally to an improved data processing system, and in particular to a method and apparatus for verifying accuracy of data. Still more particularly, the present invention provides a method and apparatus for checking the spelling of displayable text within computer source code.

2. Description of Related Art

An integrated development environment (IDE) is a set of programs run from a single user interface. For example, programming languages often include a text editor, compiler and debugger, which are all activated and function from a common menu. One example of an IDE is VisualAge for Java, which is a product available from International Business Machines Corporation. Using an IDE, a developer is able to generate new software and programs from a single interface. Further, and IDE also may provide a graphical user interface for various programming features to increase the ease of creating software and programs.

With all of these types of features, one function is still lacking with using an IDE. The present invention recognizes that checking for spelling errors using an IDE is difficult. Currently, a software developer is required to mark, cut, and paste source code into a word processor program. This code is then checked using the spell checking function in the word processor with the appropriate spelling changes being made. Then, the corrected source code is copied and pasted back into the IDE. Such a procedure is cumbersome and reduces the usability of the IDE.

Therefore, it would be advantageous to have an improved method and apparatus for spell checking text in a computer source code.

### SUMMARY OF THE INVENTION

The present invention provides a method, apparatus, and computer implemented instructions for spell checking text. Computer source code and external resource files are received for processing. Displayable text is identified within the computer source code. The displayable text is checked for errors.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of an integrated development environment (IDE) in accordance with a preferred embodiment of the present invention;

FIG. 4 is a diagram of a menu system in accordance with a preferred embodiment of the present invention;

FIG. 5 is a flowchart of a process used for a spell check function is depicted in accordance with a preferred embodiment of the present invention;

FIG. 6 is a flowchart of a process used for spelling source code using delimiters in accordance with a preferred embodiment of the present invention;

FIG. 7 is a diagram illustrating an example of a Java language resource file in accordance with a preferred embodiment of the present invention; and

FIGS. 8A and 8B is an example of C language resource file in accordance with a preferred embodiment of the present invention.

### DETAILED DESCRIPTION OF THE PREFERRED EMBODIMENT

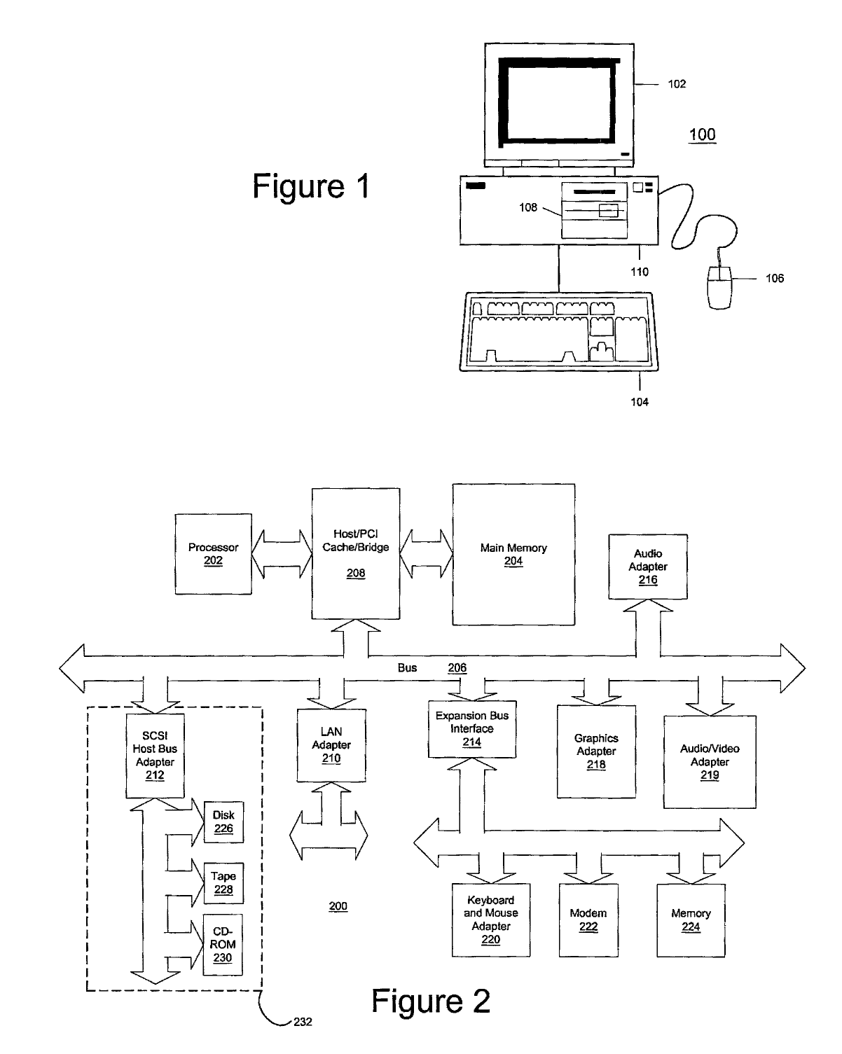

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

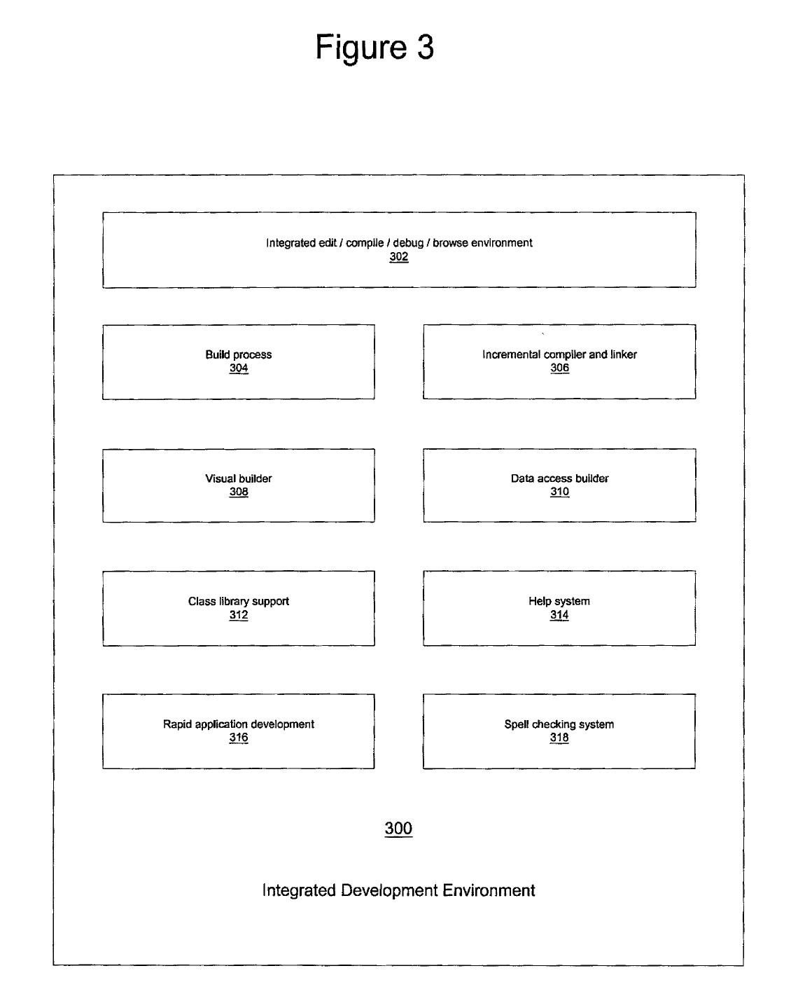

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides a method, apparatus, and computer implemented instructions for spell checking text in source code. The mechanism provides a built-in a spell check feature to improve the usability of an IDE and allow an easier mechanism to ensure the accuracy of the text in the source code. In particular, the mechanism of the present invention is directed towards spell checking displayable text, which is text that is displayed to a user on a display device when the source code is complied into a program and executed on a data processing system. In other words, displayable text is any little text used by the application code to generate graphic user interface (GUI) panels, dialogs, messages, and logs. Basically, displayable text is any human readable text output by any application.

The mechanism of the present invention uses a spell checker, which is a separate program or word processing function that tests for correctly-spelled words. A spell checker can test the spelling of a marked block, an entire document or group of documents. Advanced systems check for spelling as the user types and can correct common typos and misspellings on the fly. The mechanism of the present invention allows for the checking of displayable text, such as literal strings. To parse out or locate displayable text, the mechanism of the present invention searches for beginning and ending delimiters. The text between these delimiters are spell checked for accuracy.

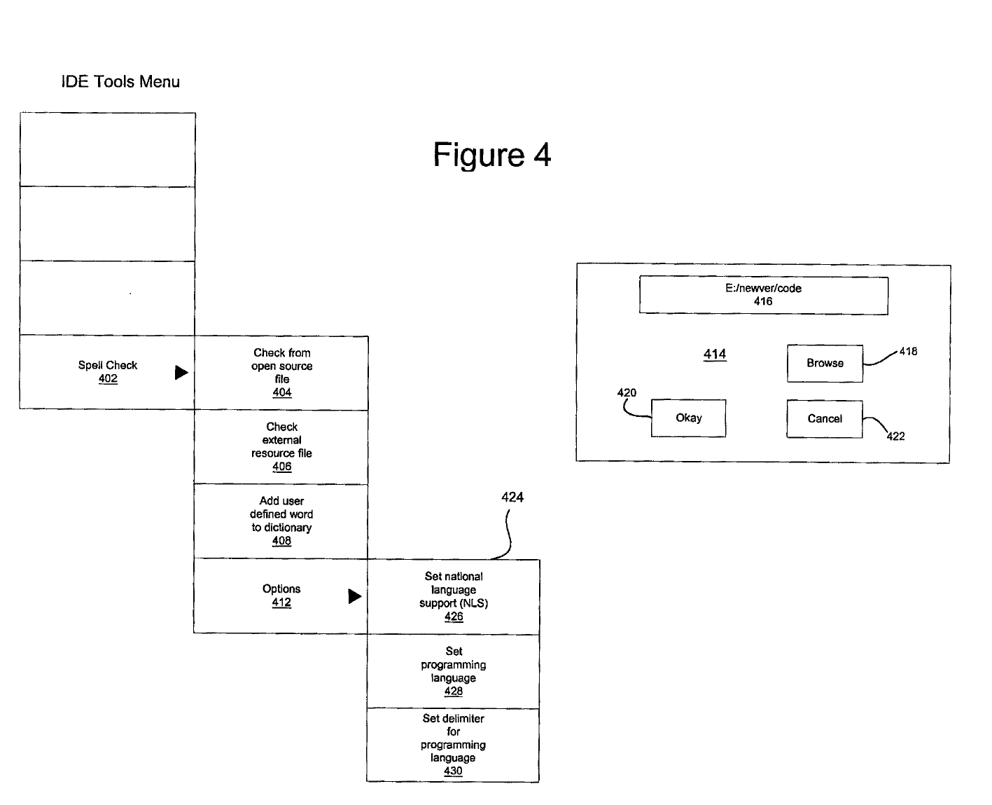

Turning next to FIG. 3, a block diagram of an integrated development environment (IDE) is depicted in accordance with a preferred embodiment of the present invention. In this example, IDE 300 includes, integrated edit/compile/debug/browse environment 302, build process 304, incremental compiler and linker 306, visual builder 308, data access builder 310, class library support 312, help system 314, rapid application development 316, and spell checking system 318. The functions other than spell checking system 318 may be found in presently available IDEs.

Spell checking system 318 implements the process of the present invention for spell checking displayable text, as well as other text within source code.

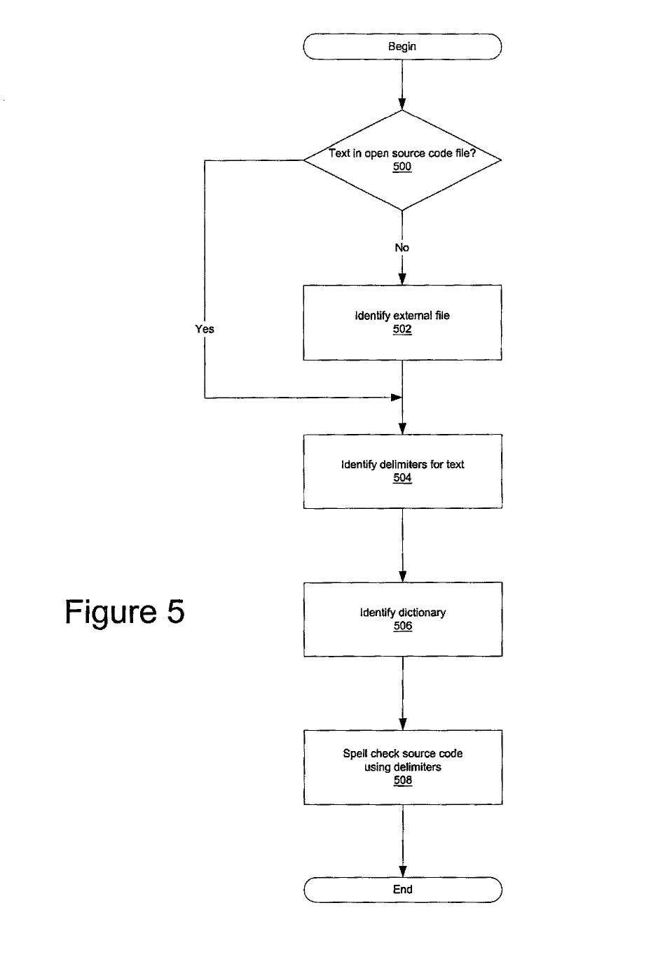

With reference next to FIG. 4, a diagram of a menu system is depicted in accordance with a preferred embodiment of the present invention. In this example, menu 400 is an IDE tools menu presented in a GUI. As illustrated, menu 400 is a drop down menu, which may be displayed by spell checking system 318 in FIG. 3 in providing spell checking features to a user. Spell check function 402 is located within this menu. When spell check function 402 is selected, a submenu 404 is presented containing “check from open source file ” function 406, “check external resource file” function 408, “add user defined word to dictionary” function 410, and options function 412.

“Check from open source file” function 406 allows the user to perform the spell checking function in the source file currently being worked on in the IDE. Selection of “check external resource file” function 408 allows the user to select another file other than the file being worked on in the IDE for spell checking. This function allows a user to specify the location of the file. In this example, popup dialog 414 is displayed in response to selection of “check external resource file” function 408. The user may enter a file path to the external resource file in field 416. Other location information, such as a universal resource identifier (URI) or a universal resource locator (URL), may be used to identify the location of the external resource file. Alternatively, instead of entering the file path name or location, the user may identify this location by selecting browse button 418, which results in a tree being presented to the user. This tree may be traversed by the user to identify a location of the external resource file. When the location is correct, the user may select okay button 420. The user may cancel this function by selecting cancel button 422.

Selection of “add user defined word to dictionary” function 410 allows a user to add words to an existing dictionary. This dictionary may be the main dictionary or a secondary dictionary of just user defined words. Selection of “options” function 412 results in the display of submenu 424, which includes the following functions: “set national language support (NLS)” function 426, “set programming language ” function 428, and “set delimiter for programming language” function 430. “Set national language support (NLS)” function 426 is used to select an appropriate dictionary used in spell checking the text. For example, a German dictionary, a French dictionary, a Japanese dictionary, or a technical dictionary may be dictionaries selectable by the user. In the depicted examples, an English dictionary is the default dictionary used for spell checking.

“Set programming language” function 428 allows the user to specify the programming language being used with the IDE or in the external resource file. Selection of the programming language allows for an identification of the type of delimiters that will be present in indicating displayable text. “Set delimiter for programming language” function 430 allows the user to set the delimiter that will be used in searching for displayable text. This function is especially useful because many programming languages allow a user to set or define delimiters.

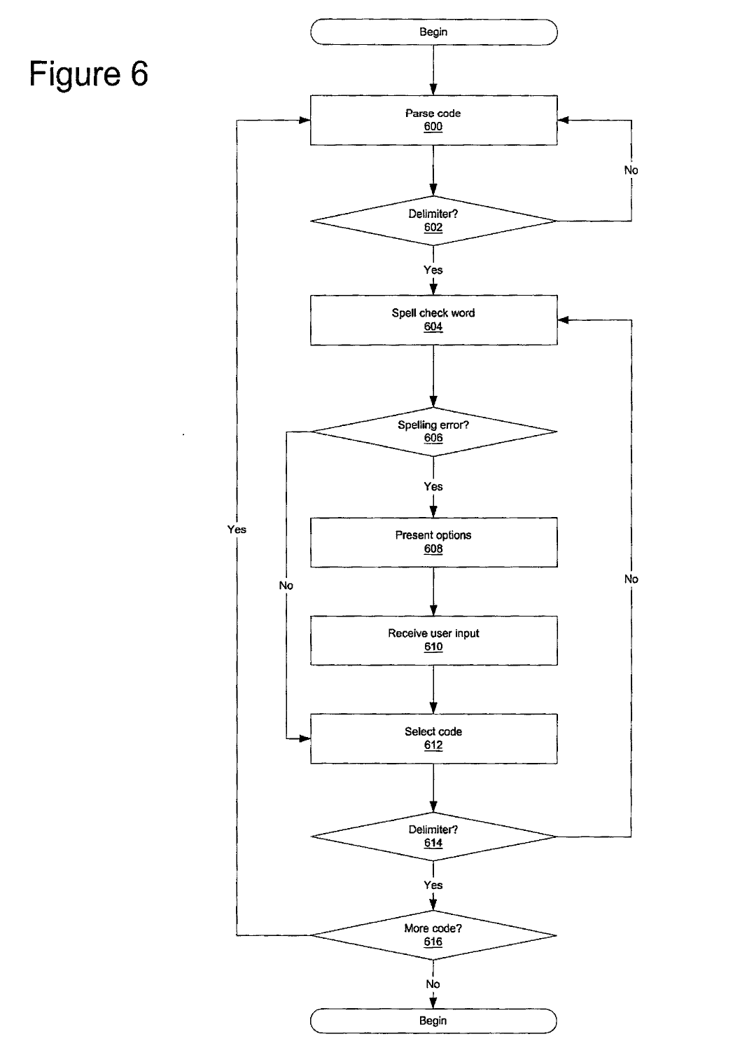

Turning now to FIG. 5, a flowchart of a process used for a spell check function is depicted in accordance with a preferred embodiment of the present invention. The process illustrated in FIG. 5 may be implemented within spell checking system 318 in FIG. 3.

The process begins by making a determination as to whether the text to be checked is located in an open source code file (step 500). If the text is not in an open source code file, an external file is located (step 502). This external file may be identified in many ways, such as, for example, using a popup dialog to enter a location of the file. Delimiters for the text to be spell checked are identified (step 504). These delimiters may be defaults for a particular programming language or entered by a user.

Next, a dictionary is identified for use in spell checking the text (step 506). This dictionary may be a default dictionary or user selected. Then, the source code is checked using the delimiters (step 508) with the process terminating thereafter.

With reference again to step 500, if the text is located in an open source code file, the process proceeds directly to step 504 a described above.

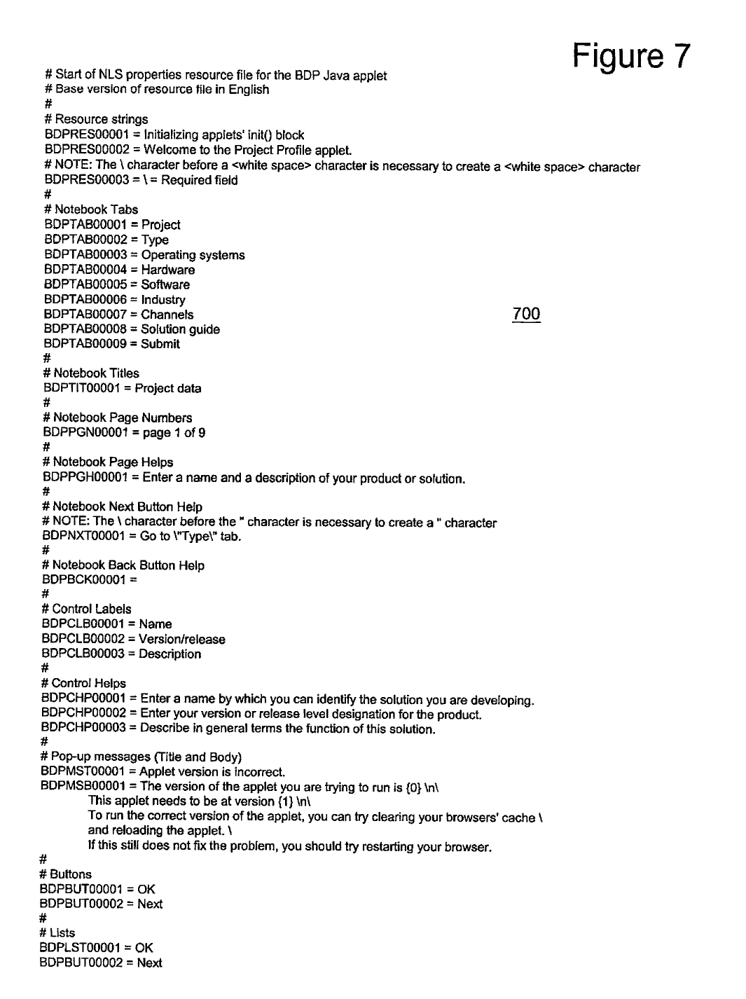

With reference now to FIG. 6, a flowchart of a process used for spelling source code using delimiters is depicted in accordance with a preferred embodiment of the present invention. The process illustrated in FIG. 6 is a more detailed description of step 508 in FIG. 5. The process begins by parsing the code (step 600). A determination is made as to whether a delimiter is present (step 602). If a delimiter is present, then the code forming a work is spell checked (step 604). A determination is made as to whether a spelling error is present (step 606). If a spelling error is present, options for correcting the spelling of the word is presented to the user (step 608). These options may include proposed spellings for the word, as well as an interface to allow the user to manually correct the spelling of the word. User input is received in response to the selects (step 610).

Next, additional code is selected for processing (step 612). A determination is made as to whether this code contains a delimiter (step 614). If a delimiter is present, a determination is made as to whether additional code is present for processing (step 616). If additional code is absent the process terminates. Otherwise, the process returns to step 600 as described above.

With reference again to step 614, if a delimiter is not present in the code, then another word is present for spell checking and the process returns to step 604. Turning back to step 606, if a spelling error is not present the process proceeds to step 612. With reference again to step 602, if a delimiter is absent, the process returns to step 600 to parse additional code.

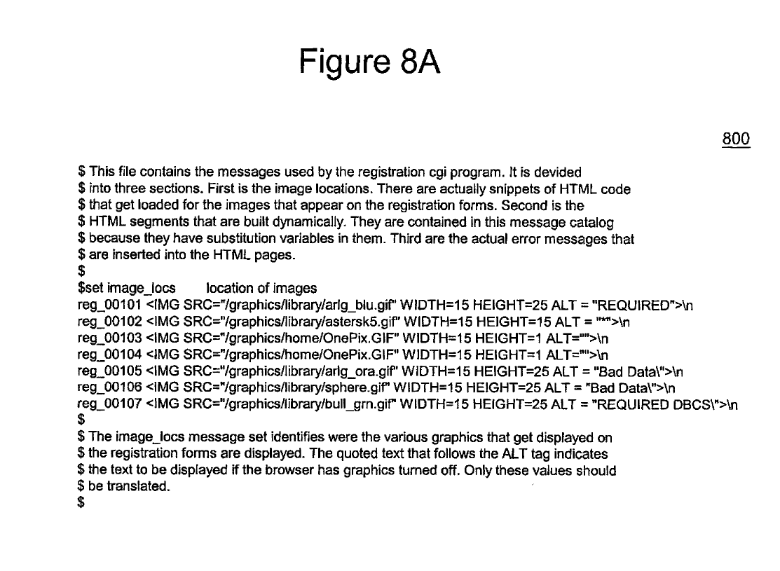

With reference now to FIG. 7, a diagram illustrating an example of a Java language resource file is depicted in accordance with a preferred embodiment of the present invention. Resource file 700 is an example of an external resource file that may be processed using the mechanism of the present invention.

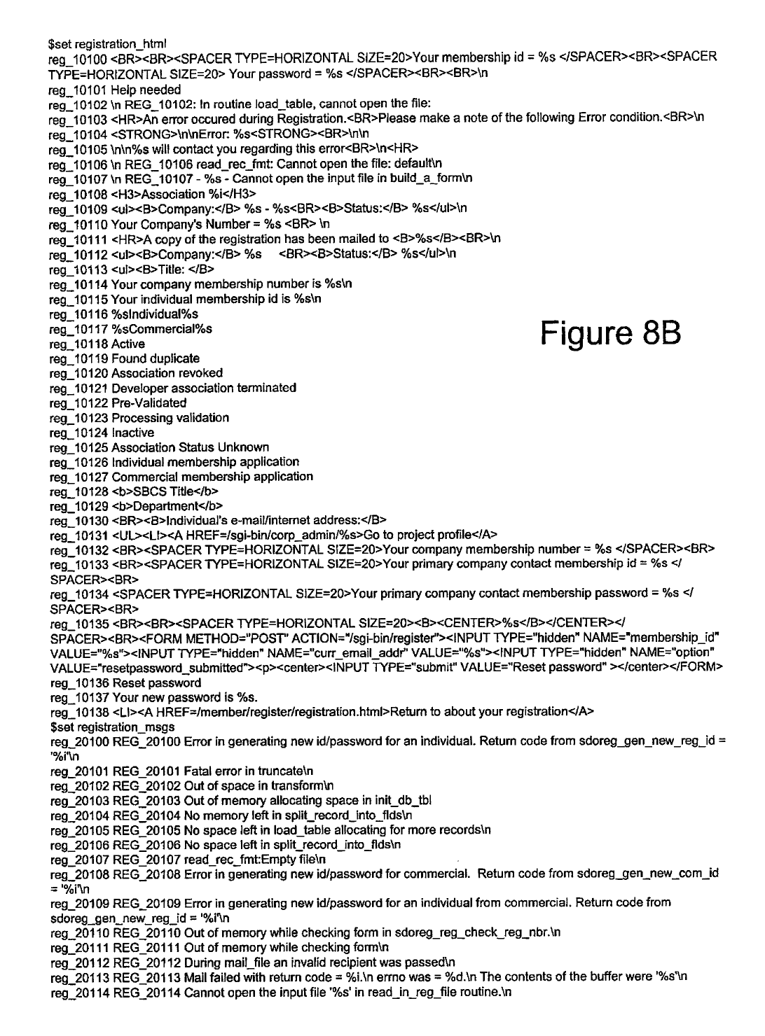

Turning next to FIGS. 8A and 8B, an example of C language resource file is depicted in accordance with a preferred embodiment of the present invention. Resource file 800 is another example of resource file that may be processed by using the mechanism of the present invention. The locations of these resource files are identified in these examples by a user input containing a path or other universal resource locator. Of course the mechanism of the present invention also may use pointers to a resource file in the source code to locate the resource file for spell checking.

Thus, the present invention provides a method, apparatus, and computer implemented instructions for spell checking text in source code. The mechanism of the present invention provides an integrated spell checker that allows for increased accuracy in user displayed text, reducing misspellings in applications.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for spell checking text, the method comprising:
receiving computer source code for processing;
identifying displayable text within the computer source code; and
checking the displayable text for errors.

2. The method of claim 1, wherein the computer source code is located in a resource file.

3. The method of claim 1, wherein the computer source code is located in a resource file.

4. The method of claim 1, wherein the identifying step comprises:
locating text between a set of delimiters as the displayable text.

5. The method of claim 1, wherein the text is a set of literal strings.

6. The method of claim 1, wherein the checking step includes:
selecting a dictionary; and
spell checking the displayable text using the dictionary.

7. The method of claim 1, wherein the dictionary is selected using a user input.

8. The method of claim 1, wherein the identifying step includes:
locating a pointer in the source code to a resource file containing the displayable text.

9. A method in a data processing system for checking text, the method comprising:
searching source code for a first delimiter indicative of displayable text; and
responsive to finding the first, spell checking text after the first delimiter until a second delimiter is encountered.

10. The method of claim 9, wherein the source code is located in a file.

11. The method claim 9, wherein the text is checked using a selected dictionary.

12. The method of claim 9, wherein the text is displayed when the source code is compiled and executed.

13. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive computer source code for processing; identify displayable text within the computer source code; and check the displayable text for errors.

14. The data processing system of claim 13, wherein the bus system includes a primary bus and a secondary bus.

15. The data processing system of claim 13, wherein the processor unit includes a single processor.

16. The data processing system of claim 13, wherein the processor unit includes a plurality of processors.

17. The data processing system claim 13, wherein the communications unit is an Ethernet adapter.

18. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to search source code for a first delimiter; and spell check text after the first delimiter until a second delimiter is encountered in response to finding the first.

19. A data processing system for spell checking text, the data processing system comprising:
receiving means for receiving computer source code for processing;
identifying means for identifying displayable text within the computer source code; and
checking means for checking the displayable text for errors.

20. The data processing system of claim 19, wherein the computer source code is located in a resource file.

21. The data processing system of claim 19, wherein the computer source code is located in a resource file.

22. The data processing system of claim 19, wherein the identifying means comprises:
locating means for locating text between a set of delimiters as the displayable text.

23. The data processing system of claim 19, wherein the text is a set of literal strings.

24. The data processing system of claim 19, wherein the checking means includes:
selecting means for selecting a dictionary; and
means for spell checking the displayable text using the dictionary.

25. The data processing system of claim 19, wherein the dictionary is selected using a user input.

26. The data processing system of claim 19, wherein the identifying means includes:
locating means for locating a pointer in the source code to a resource file containing the displayable text.

27. A data processing system for checking text, the data processing system comprising:
searching means for searching source code for a first delimiter indicative of displayable text; and
spell checking means, responsive to finding the first, for spell checking text after the first delimiter until a second delimiter is encountered.

28. The data processing system of claim 27, wherein the source code is located in a file.

29. The data processing system claim 27, wherein the text is checked using a selected dictionary.

30. The data processing system of claim 27, wherein the text is displayed when the source code is compiled and executed.

31. A computer program product in a computer readable medium for spell checking text in a data processing system, the computer program product comprising:
first instructions for receiving computer source code for processing;
second instructions for identifying displayable text within the computer source code; and
third instructions for checking the displayable text for errors.

32. A computer program product in a computer readable medium for checking text in a data processing system, the computer program product comprising:
first instructions for searching source code for a first delimiter indicative of displayable text; and
second instructions, responsive to finding the first, for spell checking text after the first delimiter until a second delimiter is encountered.
